(19) United States
(12) Patent Application Publication
(10) Pub. No.: US 2015/0149765 A1
(43) Pub. Date: May 28, 2015

(54) METHOD OF ANONYMIZATION

(71) Applicant: GEMALTO SA, Meudon (FR)

(72) Inventors: Mireille Pauliac, Meudon (FR); Beatrice Peirani, Meudon (FR); Anne-Marie Praden, Meudon (FR)

(73) Assignee: GEMALTO SA, Meudon (FR)

(21) Appl. No.: 14/406,205

(22) PCT Filed: Jun. 6, 2013
(86) PCT No.: PCT/EP2013/061694

§ 371 Date: Dec. 5, 2014

(30) Foreign Application Priority Data
Jun. 6, 2012 (EP) 12305640.0

(51) Int. Cl. G06F 21/62; H04L 29/06; H04L 29/08

(52) U.S. Cl. CPC G06F 21/6254; H04L 67/306; H04L 63/0471
USPC 713/153

(57) ABSTRACT

This invention is aimed at a method for the anonymisation of data that could help identify the user while a profile of said user is collected by a targeting data collection server. To implement such anonymisation, an anonymisation server is placed between a user terminal and the collections server. The profile data collected are encrypted by the terminal using a secret key shared with the data collection server. Those profile data supplemented with data that could help identify the user are then sent to the anonymisation server. The anonymisation server encrypts the data that could help identify the user with an anonymisation key of said anonymisation server before sending on the encrypted collected data and the anonymised identification data to said collection server.

### FIELD OF THE INVENTION

This invention is aimed at proposing an anonymisation method. The invention also relates to a system that implements such an anonymisation method.

### BACKGROUND OF THE INVENTION

Today, the spread of applications and services that rely on new technologies such as the Internet, wireless networks etc. has led to collection of larger quantities of information about users to offer them personalised services and increase efficiency. That is true for example of targeted advertising, which uses the user's profile information to offer products that could be of interest to the user. Such user information may for example be their location, using the geolocation technique offered by GPS (Global Positioning System) devices, their lifestyle through the collection of electricity consumption information from the new smart electricity grids known as ‘smart grids’, their preferences, leisure activities and even political and religious preferences by tracing and collecting information about the television programmes viewed or the websites visited through ratings applications. That information coupled with the different identifiers that make it possible to identify the user (e.g. the IP address on the Internet or information about Wi-Fi hotspots, MAC addresses, identifier of the SIM card used by a mobile telephone etc.) make it possible to narrow down the profile of users, for instance to improve the targeting of advertising on the Internet. Such targeting particularly raises problems such as:
a heightened and growing risk of invasion of privacy,
the risk of data relating to the privacy of individuals or their centres of interest, purchases etc., being diverted,
the risk of organisations or groupings that can possibly be put under surveillance or directed by totalitarian states, organised crime syndicates, cult groups, hostile competitors etc.

Such a concentration of information about individuals and its storage are a source of concern for organisations that defend the right to privacy. The protection of users' privacy is now a legal obligation in many countries. Such laws are aimed at putting in place systems to protect the privacy of users and make them aware of the risks they run when they disclose personal information. Such systems particularly involve:
requests for the user's consent before any use
of the personal data,
the management of the export of such data and communication to third parties,
the protection of the data stored on servers,
the anonymisation of personal data as early as possible

Such a legal framework around personal data slows down the deployment of applications that are nevertheless very effective, for example for increasing product sales (e.g. targeted advertising) or for balancing and optimising energy consumption (such as smart grids).

However, these laws are often unenforceable because they are inadequately supported by technology. Further, privacy protection guarantees under these laws are often not enforceable, particularly against parties that collect such data, whose servers are located outside the national territory of application of the laws.

One of the solutions for guaranteeing the protection of personal data consists in applying an anonymisation process to the handled data. Data anonymisation is a method consisting in separating the identity of the user from all their personal data. The process is aimed at making sure that a person or an individual cannot be identified through the collected data. Data collecting parties are presently required by the laws of certain countries to identify all the personal and confidential data stored in their information systems and anonymise them with appropriate security and control mechanisms.

Anonymisation tools have been created for that purpose in order to secure the storage and consultation of such personal data. The anonymisation tools are encryption means, translation means that consist in applying a translation table to the content, a ‘mask’ application that hides some of the fields in the database, means to replace personal data or means to randomly integrate fictitious data to fool the reader.

Today, a party collecting such information is required to adapt its security measures and tools to the degree of sensitivity of the personal data hosted so as to guarantee compliance with privacy laws. However, the putting in place of such measures and tools is left to the discretion of the collecting party.

Thus, a need is currently felt to improve the known anonymisation processes so as to protect personal data and thus make them anonymous, including for the collecting party.

### SUMMARY OF THE INVENTION

The invention is precisely aimed at addressing that need. To that end, the invention proposes an anonymisation process with an overall architecture of the implementing system that guarantees the protection of personal data.

The network architecture and the exchange protocols between the different parties involved are such that the ‘personal’ criterion of the handled data is eliminated at its source by the anonymisation method of the invention. With the invention, the guarantee of the anonymisation of the users' identification data is thus no longer left to the discretion of those who collect targeting data, but is provided before such data are collected.

The method according to the invention is implemented so that the parties collecting personal data can collect information about a specific user (audience measurement, opinion data, location etc.) according to their profile but without however knowing the user or their identification data, and send targeted messages (advertising, alerts etc.) suited to their profile without knowing the user or their identification data.

To that end, the invention proposes to place, between the user and the organisation that sends targeted messages, a server of a third party that helps anonymise the personal data of users that have been collected (which will be called the ‘anonymisation server’ in the remainder of the description).

Before forwarding the user's profile data to the sending organisation, the anonymisation server encrypts all the data that could potentially help identify the user with an anonymisation key, and make such identification by the sending organisation impossible.

The method according to the invention is aimed at making sure that none of the parties other than the users themselves have simultaneous access to the users' personal data and one of their identifiers allowing the attribution of their data to them.

The invention thus proposes a method for complete and permanent anonymisation, in order to protect users' personal data.

More particularly, the invention is aimed at a method for the anonymisation of data that could help identify a user while a profile of said user is collected by a data collection server, wherein said method comprises the following steps:
encryption of profile data to collect with a confidentiality key shared between said terminal and the data collection server,
transmission of the encrypted profile data to be collected and the data
that could help identify the user to an anonymisation server placed between the terminal and the collection server
encryption of the data that could help identify the user with an anonymisation key of said anonymisation server before the collected data and encrypted identification data are sent to said collection server.

The invention also relates to a system that implements such a method.

### BRIEF DESCRIPTION OF DRAWINGS

The invention will become easier to understand in the description below and the figures accompanying it. The figures are presented for information and are not limitative in any way.

FIGS. 1 and 3 respectively show a schematic representation of the architecture of a system designed to anonymise a user's identification data, in one embodiment of the invention.

FIG. 2 shows an illustration of the steps of a mode of operation of the method in the invention.

### DETAILED DESCRIPTION OF THE EMBODIMENTS OF THE INVENTION

This invention will now be described in detail by reference to a few preferred embodiments, as illustrated in the attached drawings. In the description below, numerous specific details are provided in order to allow an in-depth understanding of this invention. However, it will be clear to a person of the art that this invention can be applied without all or part of these specific details.

In order to not make the description of this invention unnecessarily obscure, well-known structures, devices or algorithms have not been described in detail.

It must be remembered that in the description, when an action is allocated to a program or a device comprising a microprocessor, that action is executed by the microprocessor commanded by instruction codes stored in a memory of that device.

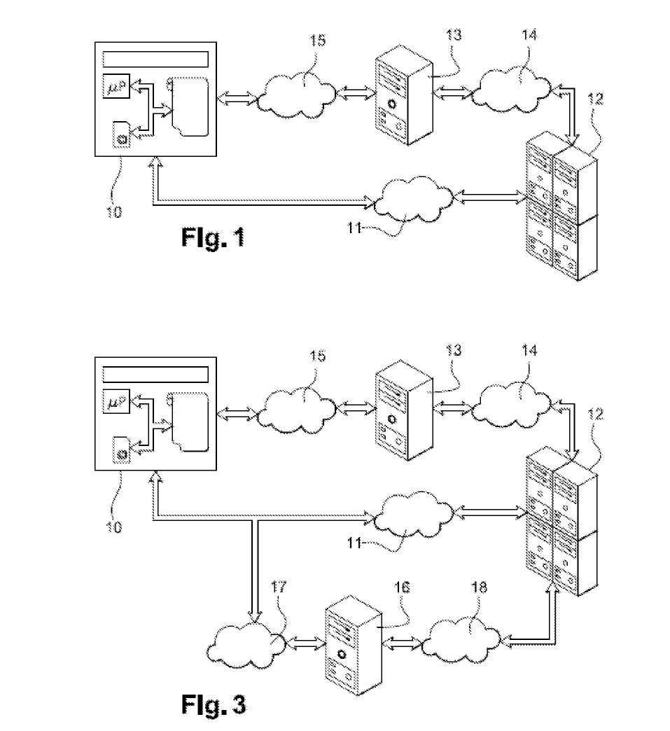

FIG. 1 is a schematic representation of an architecture of an embodiment of the invention. FIG. 1 illustrates a terminal 10 of a user connected to a first network 11. In the example of FIG. 1, the user's terminal 10 is a mobile telephone. The terminal 10 may also be a personal computer, a personal digital assistant or any equivalent device.

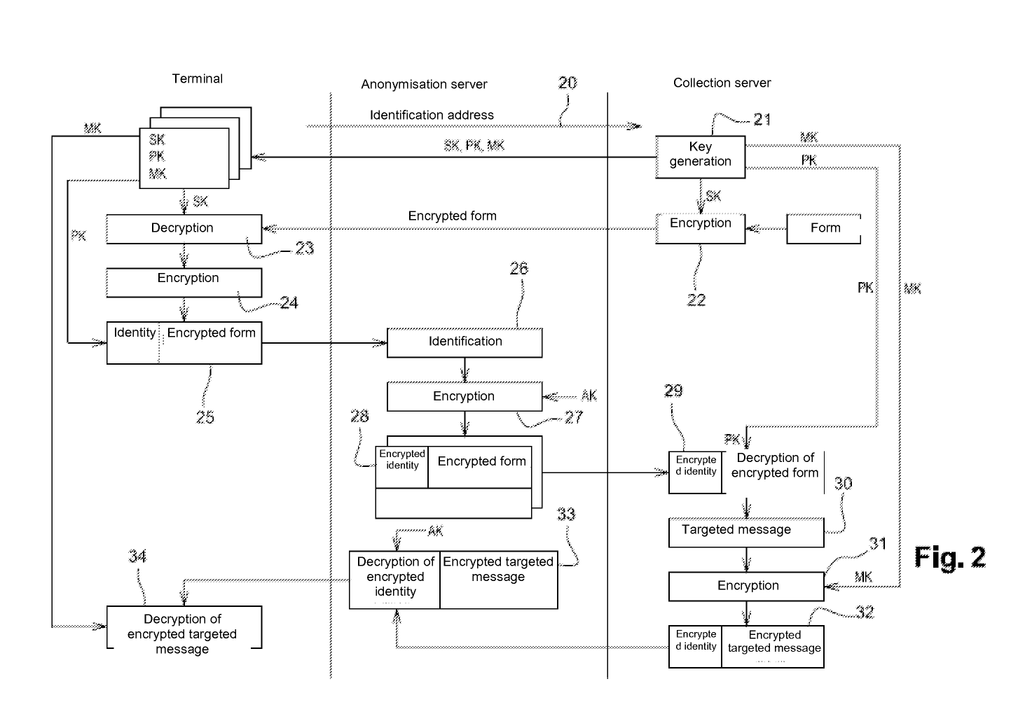

During an initialisation phase, a server 12 that collects behavioural targeting data acquires an address of the users terminal 10 in a preliminary step 20 illustrated in FIG. 2.

The address of the user's terminal 10 is an identifier that allows said terminal to set up communication and receive messages. That identification address may be any identifier associated with the user, an IMSI or an IMEI in the case of a mobile network, or also an identifier of a smart card of the users terminal 10 such as the ICCID or the TAR frame obtained by the telephone upon the booting of the smart card, wherein the identifier may also be based on any means of identification of the user from the connection operation: an IP address, an Ethernet address or even an email address, an SIP or VoIP type identifier; an ENUM type identifier or any other electronic identifier may also be envisaged.

This identification address of the terminal 10 may be obtained by the collection server 12 with the help of an inclusion list containing identification addresses of persons who have clearly stated their agreement to be on the list and receive targeted messages from said collection server. The identification address may also be obtained by the collection server 12, either during the entry of data or during a dialogue between the terminal 10 and the collection server 12 via the first network 11.

The data collection server 12 may be the server of an advertiser who could send advertisements, editorial content or descriptions of products or e-commerce services that are appropriate for the behavioural data of the user's terminal 10. The collection server 12 may also be a server of a survey or audience monitoring firm. In general, the collection server 12 may be any type of entity that collects data relating to the behaviour of users, their opinions, the identification of their centres of interest and/or their location.

The collection server 12 may also be a party that collects the electricity consumption readings of subscribers to the grid, for optimising the consumption of the electricity network or forecasting its load.

According to the invention, any communication between the user's terminal 10 and the collection server 12 comprising the data to be collected takes place through a third-party anonymisation server 13 in which the anonymisation process takes place. To that end, the terminal 10 and the anonymisation server 13 are connected by a third network 15. The anonymisation server 13 and the data collection server 12 are connected by a second network 14.

The anonymisation server 13 may be an entity that provides network access to the user and attributes an identifier to the user for communicating on said network. The anonymisation server 13 may for example be a mobile network operator, a virtual mobile network operator or an Internet service provider (ISP) with which the user has a subscription.

The anonymisation server 13 may also be the server of a specialised and recognised private body.

The term network refers to any means of communication that may for instance use technology such as: GSM, GPRS, EDGE, UMTS, HSDPA, LTE, IMS, CDMA, CDMA2000 defined by the standards 3GPP and 3GPP2 or Ethernet, Internet, Wi-Fi (wireless fidelity) and/or WiMAX, RFID (Radio Frequency Identification), NFC (Near Field Communication, which is a technology for exchanging data from a distance of a few centimetres), Bluetooth, IrDA (Infrared Data Association, for infrared file transfer) technology etc.

In one embodiment, the first network 11 is an Internet network, the second network 14 is an Internet network and the third network 15 is a mobile telephony network.

FIG. 2 shows an illustration of the steps of a mode of operation of the method according to the invention. In a step 21, the collection server 12 generates, using generation algorithms that are well known to the person skilled in the art, a set of three keys formed by a criterion key SK, a profile key PK and a message key MK. That set of three keys is generated during the initialisation phase. The set of three keys is then sent to the terminal 10 to be saved. In a preferred manner, these keys are saved securely in a memory of the terminal 10 or in a secure element of said terminal, wherein the secure element may be a smart card. The set of three keys is generated with the aim of making sure that the anonymisation server 13 can easily access communication between the terminal 10 and the data collection server 12. The key generation and exchange protocols are relatively well known to those skilled in the art and thus do not need to be described in detail.

In another embodiment, the set of three keys is generated by a key generator and then sent to the collection server 12 and the terminal 10.

During the initialisation phase, the collection server 12 prepares a list of criteria for establishing the users profile. That list may for instance include the user's sex (male or female), age, nationality, musical preference, preferred pastimes etc.

This list of criteria may also be the list of programmes viewed in the case of audience monitoring, or electricity readings in the case of an application related to the smart grids, or GPS (US geolocation system) or Galileo (European counterpart of GPS) location for location-related service applications or location-dependent targeted alerts.

This list of criteria may for example take the form of a targeting data entry form. These targeting data are used to build a profile of the user. The form includes fields to be completed by the user, which may relate among other things to their centres of interest, pastimes, opinions and/or physical characteristics (weight, height, age, sex etc.).

In a step 22, the collection server 12 then encrypts the targeting data entry form or the list of criteria using the criterion key SK. That encrypted form is sent from the collection server 12 to the terminal 10. The form may be sent during the initialisation phase directly from the collection server 12 to the terminal 10 via the first network 11 or through an intermediary that may be the anonymisation server 13.

In a step 23, the terminal 10 decrypts the encrypted form or the list of criteria with the criterion key SK saved earlier. The encryption and decryption operations of the terminal 10 may be carried out within the secure element of said terminal (when the terminal has one) or by a dedicated application.

After decryption, the entry form or the list of criteria is displayed via a graphics interface and comprises several descriptive titles that are laid out on a screen of the terminal 10 in a way as to guide the user for the entry of profile data. Following the validation of the entry by the user, the terminal 10 encrypts the form or the list of validated criteria in a step 24 using the PK profile key extracted from its database.

The users profile data may also be taken from an application downloaded in the terminal 10, which, after a learning period, using for example the viewing history of TV programmes or the websites visited or the purchases made on the Internet, deduces the user's preferences. The criteria from the previously received list allow the application to select the type of profile data that will make up the user's profile to send to the collection server 12.

In a step 25, the terminal 10 prepares a profile message including the users identification data and the profile data encrypted in step 24. That profile message is then sent to the anonymisation server 13.

The identification data may be the identification address of the terminal 10, such as the Internet address, which is the source used in the profile data transmission protocol, typically the HTTP internet protocol.

In a step 26, the anonymisation server 13 extracts from the profile message the identification data that are to be anonymised. In a step 27, the anonymisation server 13 encrypts the identification data with an anonymisation key AK generated earlier to obtain an encrypted identifier. In a step 28, the anonymisation server 13 prepares an anonymisation message comprising the anonymised identification data and the encrypted profile data received from the profile message. That anonymisation message is then sent by the anonymisation server 13 to the collection server 12. The collection server 12 cannot in any event access the users identification data since they are encrypted with a key that is not accessible to said collection server.

In a step 29, the collection server 12 decrypts the profile data encrypted with the profile key PK extracted from its database.

In a step 30, the collection server 12 searches its database for a targeted advertisement corresponding to a visual or audio message with characteristics that best match the user's profile data. That visual or audio message may include content designed to promote a product, a service, an event, a company etc. The message may also be a targeted alert, and the list is of course not exhaustive.

In another embodiment, the collection server 12 prepares statistics from the decrypted profile data, for example for an opinion, audience monitoring or electricity consumption reading.

In a step 31, the collection server 12 encrypts that targeted advertisement with the message key MK extracted from its database. In a step 32, the collection server 12 prepares a targeted message comprising encrypted identification data and the encrypted targeted advertisement. The targeted message is then sent to the anonymisation server 13. In a step 33, the anonymisation server 13 decrypts the encrypted identification data with the anonymisation key AK extracted from its database. The anonymisation server 13 then sends the encrypted targeted advertisement to the addressee terminal 10 identified by the identification data. In a step 34, the terminal 10 decrypts the encrypted targeted advertisement with the message key MK extracted from its database.

As it goes without saying, the invention is not limited to the embodiments represented in the figures, which are given as examples; on the contrary, it encompasses all the alternative implementations of the method.

In one embodiment, the anonymisation server 13 uses a deterministic encryption algorithm to encrypt the users identification data with the anonymisation key AK. That deterministic encryption algorithm is a cryptosystem that always produces the same encrypted text for the same piece of data. The collection server 12 may therefore observe the behaviour of the encrypted identifier received from the anonymisation server 13 over time. Through the profile data received for that encrypted identifier, the collection server 12 can narrow down the profile of users through a statistical analysis of the encrypted identifiers received, without knowing their identity.

In another embodiment, illustrated in FIG. 3, a third-party server 16 is placed between the collection server 12 and the user's terminal 10. To that end, the terminal 10 and that third-party server 16 are connected by a fourth network 17. The third-party server 16 and the data collection server 12 are connected by a fifth network 18. The third-party server 16 shares the anonymisation key AK with the anonymisation server 13. That anonymisation key AK may be generated by the anonymisation server 13 which then transmits it to the third-party server 16 for it to be saved, or vice versa. In an alternative, this anonymisation key may be generated by a key generator to be then sent to the anonymisation server 13 and the third server 16.

Preferably, the third-party server 16 is a trusted server of a specialised and recognised private body. In one alternative, the third-party server 16 may be an entity that provides network access to the user and attributes an identifier to the user for communicating on said network.

In this embodiment, the steps 20 to 31 illustrated in FIG. 2 are executed as described above. From step 32, the collection server 12 transmits to the third-party server 16 the targeted message comprising the encrypted targeted advertisement and the encrypted identifier. The third-party server 16 executes the step 33 and transmits the encrypted targeted advertisement to the addressee terminal 10.

Thanks to the multiplication of parties, this embodiment makes it possible to disperse user-related information in order to make it difficult to correlate.

In another embodiment, the collection server 12 transmits decrypted profile data to a content supplier, which takes charge of sending targeted advertisements. Depending on the data received from the collection server 12, the content provider selects the suitable targeted advertisement and sends it to said collection server in order to execute the steps 31 and 32 of FIG. 2.

In another embodiment, the list of criteria of the profile data is exchanged in clear form between the terminal 10 and the collection server 12 via the network 11. The encryption of the criteria is indeed optional, but preferable in order to make it more difficult to reverse the anonymisation by the anonymisation server and the third-party server.

In one embodiment, in order to optimise the management and saving of the secret keys in the collection server 12, the collection server 12 shares that set of three keys with all the users' terminals.

In another embodiment, that set of three keys may be reduced to a single secret key. That secret key may be used to encrypt all exchanges between the collection server 12 and the terminal 10.

The keys generated during the anonymisation method according to the invention are for example a word, a sequence of words, a pseudo-random number or a number that is 128 bits long; the list is not exhaustive.

In other embodiments, other cryptographic architectures may be envisaged, namely:
architecture that only uses a symmetric cryptographic algorithm, as illustrated by the embodiment of FIG. 2,
architecture that only uses an asymmetric cryptographic algorithm. In this embodiment, each key generated is a pair of private/public keys. In that case, the data will be encrypted with the public key and decrypted with the private key.
architecture made up of a combination of those two algorithms.

One may also envisage a more complex cryptographic architecture with signatures, integrity calculations etc.

Regardless of the network architecture, the cryptographic architecture and the parties selected for implementing the invention, steps must be taken to ensure that the data that allow user identification are encrypted with an anonymisation key and that exchanges between the user and the different parties are routed so that:
the targeting data collection servers are not capable of accessing information that allows user identification, and
the intermediate servers between the terminal and the collection server do not have access to the users profile.

One non-negligible benefit of the invention is that since the user's identification data are anonymised at the source, it is no longer necessary to ask for the users approval to process the data contained in the entry form, because they are no longer critical in respect of the law.

1. A method for the anonymisation of data that could help identify a user while a profile of said user is collected by a data collection server, wherein said method comprises the following steps:
encryption of profile data collected by a terminal of said user with a confidentiality key shared between said terminal and the data collection server,
transmission of encrypted profile data and data that could help identify the user to an anonymisation server placed between the terminal and the collection server, and
encryption of the data that could help identify the user with an anonymisation key of said anonymisation server before the encrypted collected data and anonymised identification data are sent to said collection server.

2. The anonymisation method according to claim 1, wherein the identification data are encrypted using a deterministic encryption algorithm.

3. The anonymisation method according to claim 1, where
upon receipt of the encrypted collected profile data, the collection server selects a targeted advertisement depending on the decrypted profile data,
the collection server sends the anonymisation server a targeted message comprising anonymised identification data and the selected targeted advertisement that is encrypted with a key shared with the terminal, and
the anonymisation server transmits the targeted advertisement to the user terminal corresponding to the decrypted identification data.

4. The anonymisation method according to claim 1, where
a trusted third-party server is placed between the user's terminal and the collection server,
the anonymisation key is shared between the third-party server and the anonymisation server,
upon receipt of the encrypted collected profile data, the collection server selects a targeted advertisement depending on the decrypted profile data, the collection server sends the third-party server a targeted message comprising anonymised identification data and the selected targeted advertisement that is encrypted with a key shared with the terminal, and
the third-party server transmits the targeted advertisement to the user terminal corresponding to the identification data decrypted with the anonymisation key.

5. The anonymisation method according to claim 3, wherein the targeted advertisement is a visual or audio message with content intended to promote a product, a service, an event, a company or a targeted alert

6. The anonymisation method according to claim 1, where the collection of profile data comprises the following steps:
preparation by the collection server of a list of targeting criteria for establishing a user profile,
transmission of the list of criteria to the terminal,
generation of profile data depending on that list of criteria.

7. The anonymisation method according to claim 6, where profile data generation is derived from entry by the user or an application of the terminal, which, after a period of learning, is capable of deducing the preferences of the user.

8. The anonymisation method according to any of claim 6, where the list of criteria comprises a request about the sex of the user (male or female), their age, nationality, musical preferences, preferred pastimes, the list of audiovisual programmes viewed, electricity consumption readings and/or the location of the user.

9. The anonymisation method according to claim 1, where the collection server and the user terminal share at least one secret key used for encrypting all the exchanges, comprising profile data, between said collection server and said terminal.

10. The anonymisation method according to claim 1, where the collection server shares with the user terminal a set of three keys, which set of three keys includes:
a criterion key designed for encrypting the list of criteria relating to the user's profile before it is transmitted by the collection server to said user terminal, a profile key designed for encrypting the profile data before they are transmitted by the user terminal to said collection server,
a message key designed to encrypt the targeted advertisement, selected depending on the user's profile, before it is transmitted by the collection server to said user terminal.

11. The anonymisation method according to claim 9, where the collection server shares the same key or the same set of three keys with a series of user terminals.

12. The anonymisation method according to claim 1, where the user terminal is a mobile telephone or a personal digital assistant or a computer.

13. The anonymisation method according to claim 1, where the data collection server is a server for sending advertisements, audience monitoring or surveys.

14. The anonymisation method according to claim 1, where the anonymisation server and the third-party server are an operator providing network access to the user of said terminal or a server of a specialised and recognised private body.

15. An anonymisation system comprising an anonymisation server placed between a user terminal and a server collecting user profile data, wherein said system comprises means capable of executing a method for the anonymisation of data that could help identify said user when the profile of said user is collected by the collection server, wherein the method for the anonymisation of data comprises:
encryption of profile data collected by a terminal of said user with a confidentiality key shared between said terminal and the data collection server,
transmission of encrypted profile data and data that could help identify the user to an anonymisation server placed between the terminal and the collection server,
encryption of the data that could help identify the user with an anonymisation key of said anonymisation server before the encrypted collected data and anonymised identification data are sent to said collection server.

16. The anonymisation system of claim 15 wherein the identification data are encrypted using a deterministic encryption algorithm.

17. The anonymisation system of claim 15 wherein the method for the anonymisation of data further comprises:
upon receipt of the encrypted collected profile data, the collection server selects a targeted advertisement depending on the decrypted profile data,
the collection server sends the anonymisation server a targeted message comprising anonymised identification data and the selected targeted advertisement that is encrypted with a key shared with the terminal, and
the anonymisation server transmits the targeted advertisement to the user terminal corresponding to the decrypted identification data.
